(19) United States
(12) Patent Application Publication
(10) Pub. No.: US 2025/0266226 A1
(43) Pub. Date: Aug. 21, 2025

(54) ELECTRICAL CONNECTION SWITCHING MEMBER HAVING PENETRATING BODY

(71) Applicant: Peter LELL, Moosburg (DE)

(72) Inventor: Peter LELL, Moosburg (DE)

(21) Appl. No.: 18/292,079

(22) PCT Filed: Jun. 30, 2022
(86) PCT No.: PCT/DE2022/100473

§ 371 Date: Jul. 15, 2024

(30) Foreign Application Priority Data
Aug. 2, 2021 (DE) 102021120055.5

(51) Int. Cl. H01H 39/00; H01H 1/06; H01H 1/20; H01H 1/50

(52) U.S. Cl. CPC H01H 39/004; H01H 1/06; H01H 39/006; H01H 1/20; H01H 2001/508

(57) ABSTRACT

The invention relates to an electrical connection switching member having at least two electrically conductive contact elements and an electrically conductive contact piece for connecting the contact elements, wherein the contact piece is movable by means of a pyrotechnic drive along a movement path, and, as a result, the connection switching member can be changed from an electrically disconnected state to an electrically connected state, wherein the contact piece is designed so that the contact piece in the disconnected state does not electrically connect the contact elements and in the connected state electrically connects the contact elements, wherein the contact piece or the contact elements have at least one penetrating body, which is designed so that, during the change from the electrically disconnected state into the electrically connected state, the penetrating body penetrates into the contact piece or the contact elements by cutting or piercing. The present invention also relates to the use of the connection switching member according to the invention for short-circuiting a circuit on a fuel cell.

The present invention relates to an electrical connection switching member that is suitable for selectively short-circuiting a circuit with current intensities of up to 150 kA, and that, in addition, requires less installation space than previous connection switching members, relays, or contactors, is significantly smaller, lighter, and more cost-effective to manufacture, and allows more reliable contact even when the switching contacts are soiled, and, when actively triggered, requires less activatable or pyrotechnic material and yet switches safely, quickly, and without contact bouncing. The switching principle can be used to good effect for circuits with an operating voltage of up to 10 kV, and the time period between the control of the electrical connection switching member and the short-circuiting of the circuit can also be reduced to 10 μsec and can thus be switched more than two orders of magnitude faster than would be possible, for example, with a relay or contactor.

Electrical connection switching members for closing circuits are used, for example, in order to remove electrical energy from a motor vehicle subsystem after a motor vehicle accident. For example, electric vehicles inverters still have capacitive energy stored after they have been switched off, which must be removed from the system as soon as possible after an accident and after the vehicle battery is disconnected, i.e., for example, converted to heat, in order to prevent a fire or explosion. For example, electrical interrupting switching members with a short-circuiting center electrode can be used for this purpose, as described, for example, in DE 10 2016 124 176 A1.

However, this is different in vehicles with fuel cells, because the energy to be dissipated from the system is significantly higher. In fuel cells, the problem is that, even though the hydrogen and oxygen supply can be cut off after an accident, there is still enough reactive fuel in the fuel cell itself in this case to produce the high energies mentioned. At such high energies, the aforementioned switches with the aforementioned center electrode are generally no longer suitable.

Flying systems powered by batteries or fuel cells, such as aircraft, helicopters, or drones, also require fast, reliable, and precision-triggered short-circuit elements, in order to—in particular in conjunction with fast, reliable, and precision-triggered circuit disconnectors—remove, for example, damaged wiring or assemblies from the electrical power supply network and then, for example, loop in substitute assemblies or take over other circuits in the network.

Therefore, the prior art provides what are known as pyro switches, in which a contact piece is moved by means of an initiator or a pyrotechnic gas generator in a direction of movement from a starting position to an end position, wherein, in the end position, two terminal contacts are connected to one another, through which the maximum short-circuit current flows. Such terminal contacts can be formed by two conductor elements arranged one behind the other in the direction of movement of the contact piece, which are then bridged by the contact piece, similar to the so-called impact switch described in DE 10 2014 110 825 A1, only with the reverse effect.

DE 10 2010 010 669 A1 shows an electrical connection switching member in which the contact piece is connected to only one of the two electrical terminal contacts prior to switching. After switching, the contact piece sits in a receiving device provided therefor, whereby a connection between the two electrical terminal contacts is established via the electrically conductive contact piece.

Another solution of the prior art is to provide a relay contact similar to a contact spring, or a hydraulic or electromagnetic relay switch.

All of the aforementioned switches of the prior art have the disadvantage of a limited current-carrying capacity, and the contact is usually only touching and thus not stable in the long term, in particular if, after an incident, not only is energy to be removed from an assembly, but also a high current-carrying capacity is to be ensured permanently and reliably. This is in particular also the case in HVDC (high-voltage direct current) transmission systems, where a defective assembly must be removed by short-circuiting a set of sub-assemblies operating serially in succession and with one another so that the remaining intact sub-assemblies can continue with their task.

Although there are electromagnetic or hydraulic relay switches or contactors in which one of the contacts has a cutting edge or a spike that can penetrate into the other contact, these switches have the disadvantages that (a) the energy for switching must be supplied from the outside, (b) they must have an energy store and therefore constitute a rather large and heavy assembly, (c) in principle, they do not allow a fast short-circuiting time in the range of 10 μs to 200 μs, (d) have a limited reliability with respect to the safe switching process, (e) cannot reliably maintain a short circuit over a long period of several years, (f) are not maintenance-free and therefore cannot be operated in a wide temperature range of −54° C. to 125° C. in, additionally, a high humidity range, and (g) have a too low power density (large volumes require high switching forces), i.e., are too slow, too large, and consume too much power.

In addition, if permanent short-circuit contacting is desired, energy would have to be constantly supplied to these switching elements in order to be able to maintain the contact force, whereas, in the case of the pyrotechnic short-circuit switch according to the invention presented here, the process gas generated during activation continues to act upon the contact element with good sealing and thus ensures permanent reliable contacting.

It is therefore the object of the present invention to provide an electrical connection switching member that overcomes the aforementioned disadvantages of the switches of the prior art.

The aforementioned object is achieved according to the invention by an electrical connection switching member of claim 1 or the use of the connection switching member of claim 9. Dependent claims 2 to 8 show further embodiments of the connection switching member according to the invention.

The electrical connection switching member according to the invention generally has at least two electrically conductive contact elements and an electrically conductive contact piece for connecting the contact elements. The contact piece is movable by means of a pyrotechnic drive along a movement path, as a result of which the connection switching member can be changed from an electrically disconnected state to an electrically connected state. The contact piece is designed so that the contact piece in the disconnected state does not electrically connect the contact elements and in the connected state electrically connects the contact elements. The contact piece or the contact elements have at least one penetrating body, which is designed so that, during the change from the electrically disconnected state into the electrically connected state, the penetrating body penetrates into the contact piece or the contact elements by cutting or piercing.

According to the invention, “penetrates by cutting or piercing” is to be understood to mean that a portion of the contact piece penetrates into the contact elements, or in each case a portion of the contact elements penetrates into the contact piece, in such a way that the body of the corresponding contact piece or the corresponding contact elements is cut or pierced through the surface. This results in intimate contact between the contact piece and contact elements, even if the contact elements or the contact piece are heavily soiled or have an oxide layer. In this way, a permanent short-circuiting can be ensured with high reliability, even at high current intensities and high voltages. Furthermore, the contact piece and contact elements can also be fused together, which also increases reliability.

Furthermore, it is preferred that the pyrotechnic material be located within a housing together with the contact piece and the contact elements. This has the advantage that, unlike relay switches, the power for switching does not have to be supplied from the outside. In this way, a compact assembly can be provided that has requires less space than conventional relay switches. Furthermore, the use of a pyrotechnic material has the advantage that extremely fast switching, even without the use of contact bouncing, is possible with a short-circuit time in the range of 10 μs to 200 μs, which requires a relatively large installation space, wherein, apart from an extremely low activation energy of approximately 5 to 25 mWs, depending upon the initiator or pyrotechnic gas generator used, no external energy required for the actual switching and penetration has to be supplied from the outside, so that the assembly is thus energy-independent.

Due to the compact design of the connection switching member according to the invention, a relatively small amount of pyrotechnic material is sufficient for reliable switching. The connection switching member according to the invention can thereby be provided in a relatively small, light, and cost-effective form. In contrast to conventional switches of the prior art, such as relay switches, the connection switching member according to the invention is operable without maintenance for many years to many decades, even in a wide temperature range and possibly also in an ambient atmosphere with high humidity, as mentioned at the outset.

The aforementioned advantages according to the invention are achieved in particular by the combination of the cutting or piercing penetration of the penetrating bodies and the use of a pyrotechnic drive for moving the contact piece. Short-circuiting of such high currents at high voltages was not necessary before the advent of vehicles with fuel cells, which is why such a combination has hitherto not been considered in the prior art.

In one embodiment of the connection switching member according to the invention, it is preferred that the penetrating body be designed as a wedge, cutting edge, or spike. According to the invention, a wedge is understood to mean a body in which two side surfaces converge at an acute or small angle. According to the invention, a cutting edge is understood to mean the sharpened part of a blade. According to the invention, a spike can be a needle or a conical element. If the penetrating body is a cutting edge, it can be present in the form of a linear cutting edge or a non-linear cutting edge. In the case of a non-linear cutting edge, it is preferred that the penetrating body be in the form of a cylinder, on one side of which the edge(s) has/have (a) cutting edge(s), wherein the base surface of the cylinder can be circular or triangular or polygonal.

In one embodiment of the connection switching member according to the invention, it is preferred that the contact piece, the contact elements, and/or the penetrating body be made of an electrically conductive material or coated with an electrically conductive material. The electrically conductive material is preferably metal or a conductive plastic. More preferably, the contact piece, the contact elements, and/or the penetrating body are made of metal—preferably stainless steel, copper, or brass. In particular, it is preferred that the contact piece having the penetrating body or the contact elements having a penetrating body, and the penetrating body be made of a metal—preferably stainless steel, copper, or brass. In this case, the contact piece or the contact elements into which the penetrating body cuts or pierces can be made of metal or a conductive plastic. Furthermore, it is preferred according to the invention that the contact piece having the penetrating body and the penetrating body be made of the same material. Preferably, the contact piece having the penetrating body and the penetrating body are of one piece. The same preferably also applies to the corresponding contact element when it includes the penetrating body.

In one embodiment of the connection switching member according to the invention, the contact piece itself can be designed as a piston that is movable by means of the pyrotechnic drive along the movement path. In a further embodiment, the contact piece can be connected to a piston, at least in the disconnected state of the connection switching member, wherein the piston is movable by means of the pyrotechnic drive along the movement path.

The pyrotechnic drive preferably includes a pyrotechnic material. A pyrotechnic material is understood to mean substances that, after the application of activation energy, completely or partially decompose in gaseous form, as well as pyrotechnic charges or chemical mixtures, such as, for example, tetrazene, nitrocellulose, ZPP (zirconium potassium perchlorate), TPP (titanium potassium perchlorate), and substances of explosive chemistry such as silver azide, lead azide, hexogen, octogen, or nitropenta, and mixtures thereof. The pyrotechnic drive or the pyrotechnic material is controllable, i.e., it can be actively ignited by a controller. The pyrotechnic drive is preferably triggered when a circuit is selectively short-circuited, and the contact elements are to be selectively connected to one another (multi-contact system).

The pyrotechnic material described above can be electrically activated by glow wire (bridge wire initiator), spark flashover (spark detonator), direct passage of current (electric initiator), wire explosion (EBW), foil acceleration (EFI), friction, impact, light irradiation (laser initiation), or microwave introduction.

The pyrotechnic drive preferably sits behind the piston mentioned above, i.e., on the side of the piston opposite the side on which the contact piece is located, or on the side of the piston opposite the side on which the contact elements are contacted by the contact piece designed as a piston. The pyrotechnic drive can move the piston itself directly along the movement path, or it can move the piston indirectly in that a further piston is located between the one piston and the pyrotechnic drive. The one piston and/or the further piston is/are preferably guided through a combustion chamber/piston housing so that it/they is/are moved along the desired movement path towards the contact elements.

The geometry described here is what is known as a pyrotechnic force element, in which the gas-loaded piston presses the contact piece against the contact elements.

As an alternative to the aforementioned pyrotechnic force element, according to the invention, what is known as a pyrotechnic pin puller can also be used, which is preferably designed so that the contact piece is pulled towards the contact elements. For this purpose, the connection switching member according to the invention preferably has a sabot in a sabot housing. The sabot can be moved within the sabot housing when the pyrotechnic drive is triggered. The sabot is preferably connected to the contact piece and pulls it towards the contact elements after the pyrotechnic drive is triggered and during the change from the disconnected state to the connected state.

However, the aforementioned pyrotechnic force element is preferred according to the invention because it has the advantage of a significantly higher force at the same charge compared to the aforementioned pyrotechnic pin pullers, because, in the case of pin pullers, only one annular surface can act as a force-generating, gas-loaded surface.

Preferably, the one or the further piston is designed so that, together with the combustion chamber/piston housing, it delimits a combustion chamber in which the pyrotechnic drive is located. In this case, the one or the further piston is guided from the combustion chamber/piston housing so that it can be moved along the aforementioned direction of movement when the pyrotechnic drive is ignited. The contact piece is moved towards the contact elements, and the connection switching member is changed from the disconnected state to the connected state.

In one embodiment of the connection switching member according to the invention, it can have two contact elements that are bridged during the change from the disconnected state to the connected state. In a further embodiment, the connection switching member according to the invention can have three or more contact elements (multi-contact system). The contact piece is preferably designed so that the contact piece in the disconnected state does not electrically connect the contact elements and in the connected state electrically connects the three or more contact elements. In this way, a plurality of switching circuits can be short-circuited at the same time. For example, one or more capacitors or motors can be short-circuited and connected to ground at the same time, or a plurality of circuits can be connected or short-circuited independently of one another, as may be the case, for example, for network tasks after the failure of assemblies in an aircraft, where defective assemblies or cables may only be bridged and not simply be disconnected. Unlike electric vehicles on the ground, the battery or the fuel cell in an aircraft must continue to operate even after an incident to prevent it from crashing. In the case of the aforementioned multi-contact systems, the contact piece can have the penetrating body/bodies. In this case, there can be a plurality of penetrating bodies, e.g., in the form of wedges, spikes, or cutting edges, so that a penetrating body penetrates into each of the contact elements. On the other hand, there may be only one penetrating body on the contact piece, which penetrating body is designed so that it penetrates all contact elements simultaneously, e.g., in the form of a linear cutting edge (in this case, contact elements preferably arranged side-by-side in a line) or a non-linear cutting edge (in this case, contact elements preferably not arranged in a line). In the case of a non-linear cutting edge, it is preferred that the penetrating body be in the form of a cylinder, on one side of which the edge(s) has/have (a) cutting edge(s), wherein the base surface of the cylinder can be circular or triangular or polygonal. In this case, the contact elements are arranged in such a way that the cutting edge(s) penetrate all contact elements simultaneously. However, it is also conceivable for each of the three or more contact elements to have a penetrating body. In the latter case, the contact piece is designed so that all penetrating bodies of the three or more contact elements penetrate the contact piece.

In one embodiment, it is preferred that the contact elements be arranged at essentially the same distance from the contact piece in the disconnected state of the connection switching member according to the invention. In this way, the contact piece can electrically connect the contact elements simultaneously. As a result, the connection switching member according to the invention can be switched at high speed.

The present invention also relates to the use of the connection switching member according to the invention for short-circuiting a circuit on a fuel cell.

The present invention also relates to the use of a membrane or material weakening in the housing of a connection switching member according to the invention for short-circuiting a circuit as a protective function against bursting of the housing during the switching process—in particular, when the connection switching member is overloaded—for example, due to the formation of an excessively strong arc during the switching process. “In the housing” is to be understood as meaning that the membrane or the material weakening is arranged in the wall or a cover of the housing. “Overload” is to be understood to mean an overload of at least 20% of the technical nominal data of the connection switching member, and more preferably an overload of at least 50%.

The present invention will now be described with reference to the following figures. In the embodiments according to the invention shown, all features shown in one embodiment can also be transferred to the other embodiments, unless this is technically impossible:

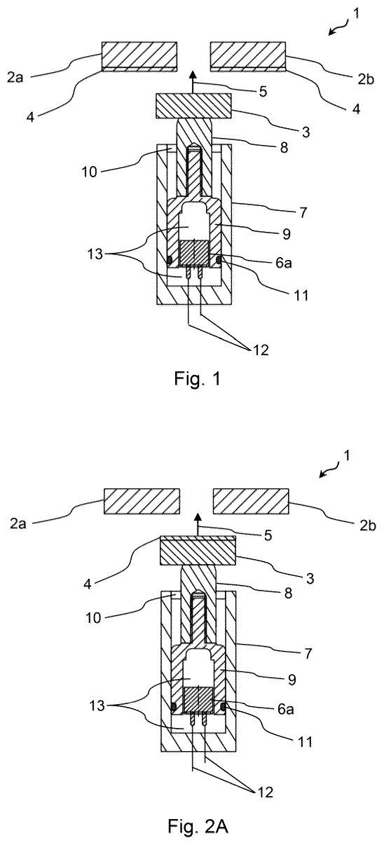

FIG. 1 shows an electrical connection switching member according to the invention in the electrically disconnected state in a section along the axis of the movement path of the contact piece, wherein the contact elements have cutting edges as penetrating bodies.

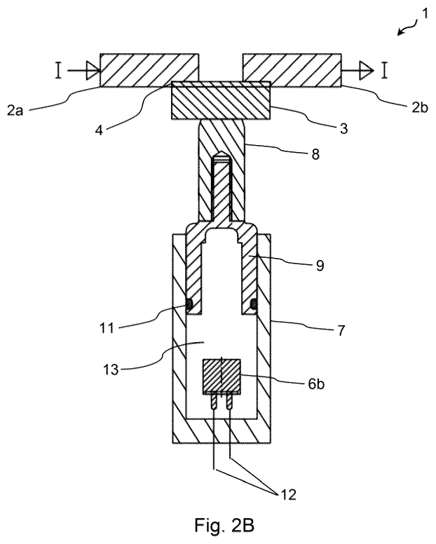

FIG. 2A shows an electrical connection switching member according to the invention in the electrically disconnected state in a section along the axis of the movement path of the contact piece, wherein the contact piece has a cutting edge as a penetrating body.

FIG. 2B shows an electrical connection switching member according to the invention in the electrically connected state in a section along the axis of the movement path of the contact piece, wherein the contact piece has a cutting edge as a penetrating body.

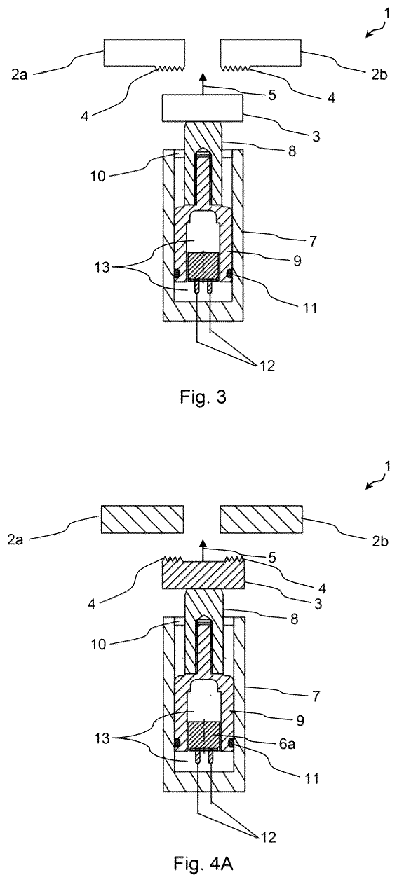

FIG. 3 shows an electrical connection switching member according to the invention in the electrically disconnected state in a section along the axis of the movement path of the contact piece, wherein the contact elements have spikes as penetrating bodies.

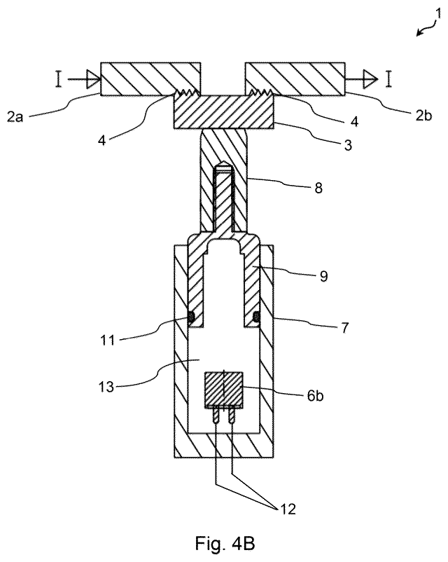

FIG. 4A shows an electrical connection switching member according to the invention in the electrically disconnected state in a section along the axis of the movement path of the contact piece, wherein the contact piece has spikes as penetrating bodies.

FIG. 4B shows an electrical connection switching member according to the invention in the electrically connected state in a section along the axis of the movement path of the contact piece, wherein the contact piece has spikes as penetrating bodies.

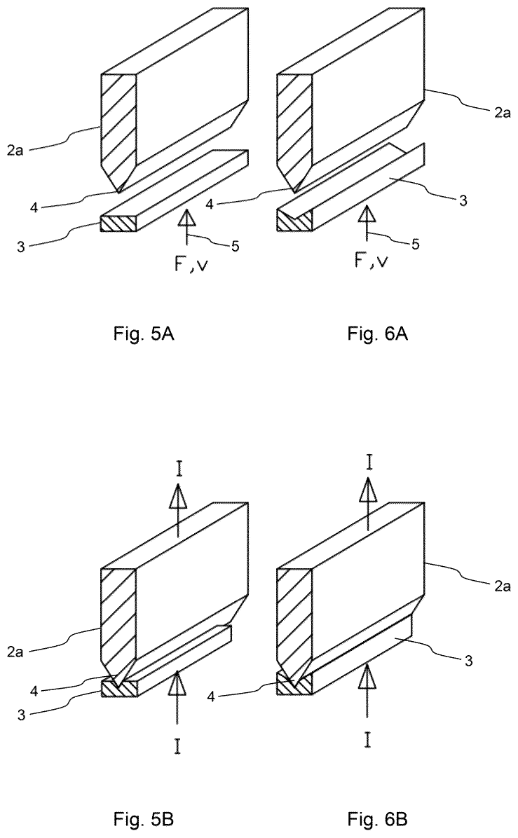

FIG. 5A and 6A show contact pieces/contact element pairs that can be used according to the invention in the electrically disconnected state in a perspectival view, wherein the contact element has a cutting edge as a penetrating body.

FIG. 5B and 6B show contact pieces/contact element pairs usable according to the invention in the electrically connected state in a perspectival view, wherein the contact element has a cutting edge as a penetrating body.

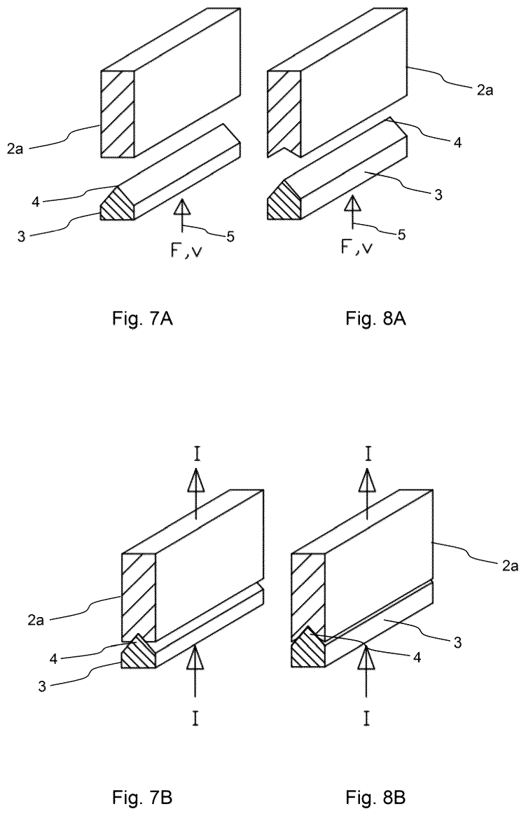

FIG. 7A and 8A show contact pieces/contact element pairs usable according to the invention in the electrically disconnected state in a perspectival view, wherein the contact piece has a cutting edge as a penetrating body.

FIG. 7B and 8B show contact pieces/contact element pairs usable according to the invention in the electrically connected state in a perspectival view, wherein the contact piece has a cutting edge as a penetrating body.

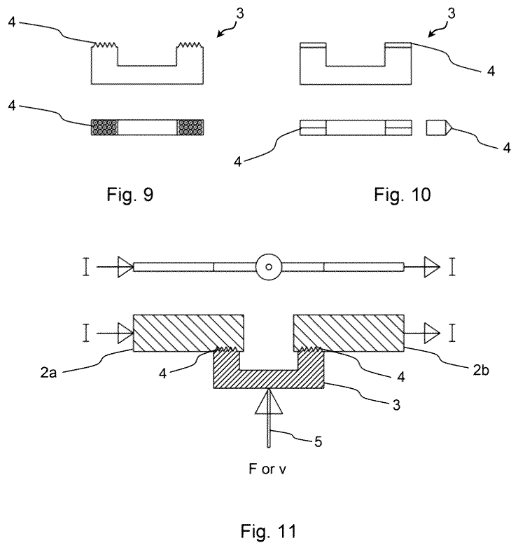

FIG. 9 at the top shows a side view of a contact piece as a U-shaped element with spikes as penetrating bodies. At the bottom, FIG. 9 also shows the same contact piece, but tilted downwards by 90°.

FIG. 10 at the top shows a side view of a contact piece as a U-shaped element with two cutting edges as penetrating bodies. At the bottom, FIG. 10 also shows the same contact piece, but tilted downwards by 90°.

FIG. 11 at the bottom shows a side view of an arrangement of two contact elements that can be used according to the invention and has a U-shaped contact piece, wherein the contact elements are electrically connected to one another via the U-shaped contact piece, wherein the contact piece has spikes as penetrating bodies. At the top, FIG. 11 also shows the same arrangement, but tilted upwards by 90°.

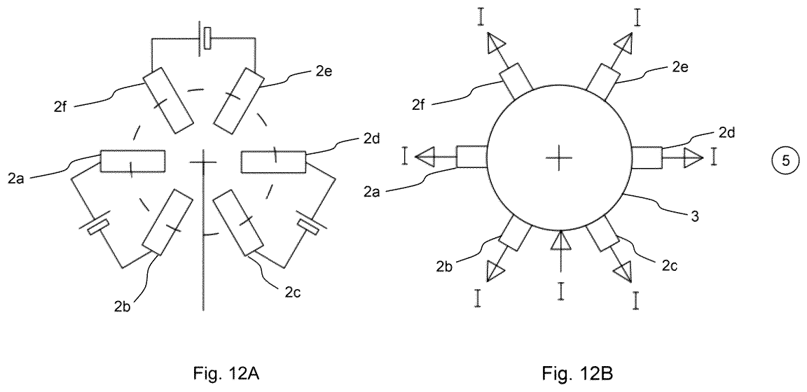

FIG. 12A shows an arrangement of a plurality of contact elements that can be used according to the invention in the electrically disconnected state and can be connected to one another via a single contact piece.

FIG. 12B shows the arrangement of a plurality of contact elements according to FIG. 12A in the electrically connected state that are connected to one another via a single contact piece.

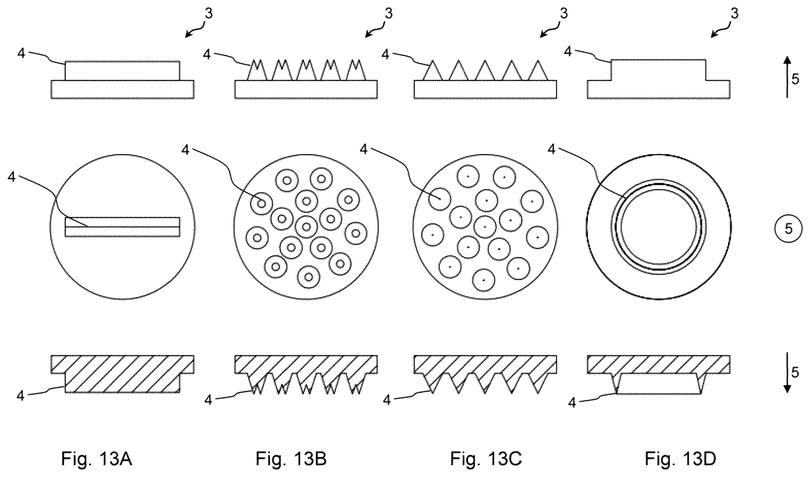

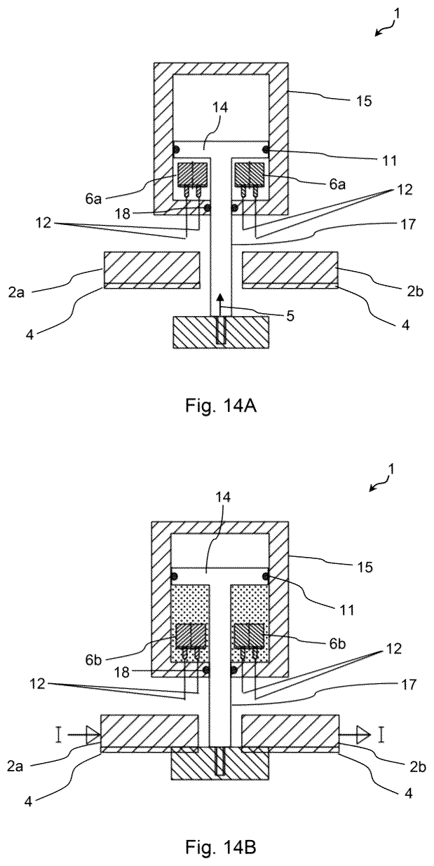

FIG. 13A to 13D at the top show side views of various contact pieces that can be used according to the invention. The middle views show the same contact pieces tilted downwards by 90°. The lower views show cross-sections of the contact pieces of the middle views, but again tilted downwards by 90°.

FIG. 14A shows an electrical connection switching member according to the invention in the electrically disconnected state in a section along the axis of the movement path of the contact piece, wherein the contact elements have cutting edges as a penetrating body, wherein the contact piece can be pulled towards the contact elements.

FIG. 14B shows an electrical connection switching member according to the invention in the electrically connected state in a section along the axis of the movement path of the contact piece, wherein the contact elements have cutting edges as penetrating bodies, wherein the contact piece has been pulled towards the contact elements.

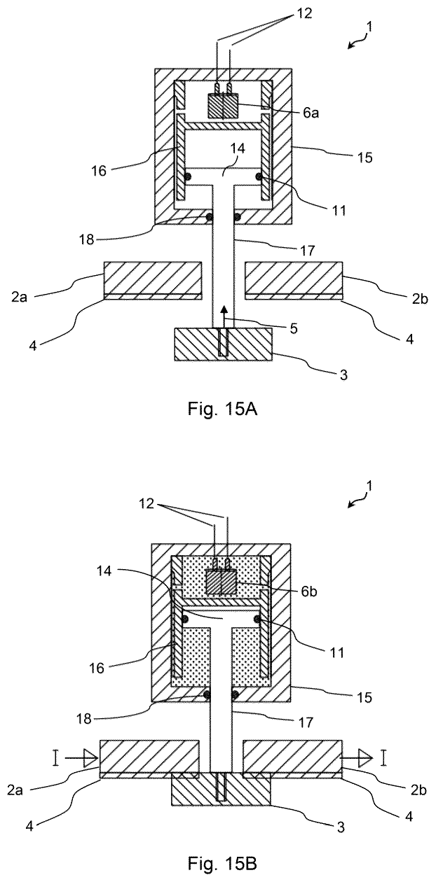

FIG. 15A shows an electrical connection switching member according to the invention in the electrically disconnected state in a section along the axis of the movement path of the contact piece, wherein the contact elements have cutting edges as a penetrating body, wherein the contact piece can be pulled against the contact elements, and with a gas-conducting body.

FIG. 15B shows an electrical connection switching member according to the invention with a gas-conducting body in the electrically connected state in a section along the axis of the movement path of the contact piece, wherein the contact elements have cutting edges as a penetrating body, wherein the contact piece has been pulled against the contact elements.

FIG. 1 shows an electrical connection switching member 1 according to the invention in the electrically disconnected state in a section along the axis 5 of the movement path of the contact piece 3, wherein the contact elements 2a and 2b have cutting edges as penetrating bodies 4. The two cutting edges of the penetrating bodies 4 are located on the side, opposite to the direction 5 of the movement path, of the electrical contact elements 2a and 2b, so that the contact piece 3 moving along the movement path strikes the side, on which the penetrating bodies 4 are located, of the contact elements 2a and 2b. In the electrical connection switching member 1 of FIG. 1, the contact piece 3 is present as an electrically conductive plate or as an electrically conductive block, so that, in the connected state, it electrically bridges the contact elements 2a and 2b. In this case, the penetrating bodies 4 designed as cutting edges cut into the contact piece 3, as a result of which an intensive electrical contact between the contact piece 3 and the contact elements 2a and 2b is produced. In the disconnected state, the contact piece 3 is preferably connected to a first piston 8, which is preferably connected to a second piston 9. The second piston 9 is preferably designed as a cylindrical piston guided by the combustion chamber/piston housing 7. Alternatively, however, first and second pistons 8 and 9 can also be manufactured in one piece. Likewise, the contact piece and the first piston 8 or the contact piece 3, the first and the second pistons 8 and 9 can also be manufactured in one piece. As shown by way of example in FIG. 1, the second piston 9 is preferably designed as a hollow cylinder open on one side, so that the hollow cylinder can receive the pyrotechnic drive 6a. The same also applies if the first and second pistons 8 and 9, or the contact piece 3 and the first and second pistons 8 and 9, are designed in one piece. The second piston 9 and the combustion chamber/piston housing 7 thereby delimit the combustion chamber 13 in which the pyrotechnic drive 6a is located. The pyrotechnic drive can be controlled and triggered by electrical terminals 12. The electrical terminals 12 are preferably led through the housing 7 to the outside in order to be able to control the pyrotechnic drive 6a outside of the housing 7. All components shown in FIG. 1 are preferably located inside a further housing (not shown). In order for the combustion chamber to be sealed to the outside, the second piston 9 can have a piston seal 11. Furthermore, the housing 7 is preferably designed as a hollow cylinder open on one side. In this case, the piston seal 11 preferably surrounds the second piston 9 in an annular manner. However, other geometries are also conceivable for the housing 7. Furthermore, the housing 7 can have one or more stop elements 10 for the second piston 9, which stop elements prevent the second piston 9 from being able to fully exit the housing during the change from the disconnected state to the connected state.

FIG. 2A also shows an electrical connection switching member 1 according to the invention as in FIG. 1 in the electrically disconnected state in a section along the axis 5 of the movement path of the contact piece 3, except that, in this case, the contact piece 3 has a cutting edge as a penetrating body 4. In this case, the cutting edge extends, by way of example, linearly and is designed so that it can penetrate both contact elements simultaneously. Otherwise, the connection switching member in FIG. 2A is constructed in the same way as the connection switching member in FIG. 1.

FIG. 2B shows the electrical connection switching member 1 according to the invention of FIG. 2A in the electrically connected state in a section along the axis 5 of the movement path of the contact piece 3. In this case, the pyrotechnic drive 6b has been ignited, and the pistons 8 and 9 are moved along the axis 5 of the movement path. As a result, the contact piece 3 connected to the first piston 8 is moved along the axis 5 of the movement path, and the penetrating body 4 designed as a cutting edge penetrates the contact elements 2a and 2b.

FIG. 3 shows an electrical connection switching member 1 according to the invention in the electrically disconnected state in a section along the axis 5 of the movement path of the contact piece 5, wherein the contact elements 2a and 2b have spikes as penetrating bodies 4. Otherwise, the connection switching member 1 of FIG. 3 is constructed in the same way as the connection switching member 1 of FIG. 1.

FIG. 4A shows an electrical connection switching member 1 according to the invention in the electrically disconnected state in a section along the axis 5 of the movement path of the contact piece 3, wherein the contact piece 3 has spikes as penetrating bodies 4. Otherwise, the connection switching member 1 of FIG. 4A is constructed in the same way as the connection switching member 1 of FIG. 3.

FIG. 4B shows the electrical connection switching member 1 according to the invention of FIG. 4A in a section along the axis 5 of the movement path of the contact piece 3, wherein the contact piece 3 has spikes as penetrating bodies 4.

FIG. 5A and 6A show contact pieces/contact element pairs 3 and 2a that can be used according to the invention in the electrically disconnected state in a perspectival view, wherein the contact element 2a has a cutting edge as a penetrating body 4. In FIG. 5A, the contact piece 3 is illustrated with a flat surface. However, the contact piece 3 can also have a notch, the deepest point of which preferably runs parallel to the cutting edge of the penetrating body 4, as shown in FIG. 6A. The direction 5 of the movement path of the contact piece 3 is indicated in each case by the arrow in FIG. 5A and 6A. When a force F is applied to the contact piece 3 by the pyrotechnic drive 6a, the contact piece moves towards the contact element 2a at a certain speed v. If the contact piece 3 strikes the contact element 2a, the cutting edge of the contact element 2a cuts into the contact piece 3. FIG. 5B and 6B show the contact piece/contact element pairs 3 and 2a in the electrically connected state in a perspectival view. The current I can now flow through the two elements 3 and 2a.

FIG. 7A and 8A show contact pieces/contact element pairs 3 and 2a that can be used according to the invention in the electrically disconnected state in a perspectival view, wherein the contact piece 3 has a cutting edge as a penetrating body 4. In FIG. 7A, the contact element 2a is illustrated with a flat surface. However, the contact element 2a can also have a notch, the deepest point of which preferably runs parallel to the cutting edge of the penetrating body 4, as shown in FIG. 8A. The direction 5 of the movement path of the contact piece 3 is indicated in each case by the arrow in FIG. 7A and 8A. When a force F is applied to the contact piece 3 by the pyrotechnic drive 6a, the contact piece moves towards the contact element 2a at a certain speed v. If the contact piece 3 strikes the contact element 2a, the cutting edge of the contact piece 3 cuts into the contact element 2a. FIG. 7B and 8B show the contact piece/contact element pairs 3 and 2a in the electrically connected state in a perspectival view. The current I can now flow through the two elements 3 and 2a.

FIG. 9 at the top shows a side view of a contact piece 3 that can be used according to the invention as a U-shaped element with spikes as penetrating bodies 4. At the bottom, FIG. 9 also shows the same contact piece 3, but tilted downwards by 90°. In this case, the contact piece 3 preferably has two regions with spikes at the two ends of the U-shaped element. With these two regions, the contact element 3 can contact two contact elements 2a and 2b, as shown, for example, in FIG. 11. The U-shape of the contact piece has the advantage that it does not come into contact with an insulator between the two contact elements 2a and 2b, or, in the connected state of the connection switching member, the contact piece 3 has a space for an insulator between the contact elements 2a and 2b. The insulator between the contact elements 2a and 2b can prevent a leakage current or the formation of an arc between the two contact elements 2a and 2b. FIG. 10 at the top also shows a side view of a contact piece 3 as a U-shaped element, but with two cutting edges as penetrating bodies 4. At the bottom, FIG. 10 also shows the same contact piece 3, but tilted downwards by 90°. The contact piece 3 of FIG. 10 is identical to the contact piece of FIG. 9, except for the different penetrating bodies 4.

FIG. 11 at the bottom shows a side view of an arrangement of two contact elements 2a and 2b that can be used according to the invention with a U-shaped contact piece 3, wherein the contact elements 2a and 2b are electrically connected to one another via the U-shaped contact piece 3, wherein the contact piece 3 has spikes as penetrating bodies 4. At the top, FIG. 11 also shows the same arrangement, but tilted upwards by 90°. In this case, the contact piece 3 has been driven into the contact elements 2a and 2b with the spikes with a force F and a speed v, as a result of which a current I can flow from the contact element 2a via the contact piece 3 to the contact element 2b by means of the arrangement.

FIG. 12A shows an arrangement of a plurality of contact elements 2a to 2f (multi-contact system) that can be used according to the invention in the electrically disconnected state and can be connected to one another via a single contact piece 3. FIG. 12A shows the arrangement of the contact elements 2a to 2f along the axis 5 of the movement path, i.e., the axis 5 of the movement path is perpendicular to the plane of the paper. In this case, a plurality of circuits can be short-circuited by bridging the contact elements 2a to 2f. In this case, one or more capacitors or motors can be short-circuited and connected to ground at the same time, or a plurality of circuits can be connected or short-circuited independently of one another, as may be the case, for example, for network tasks after the failure of assemblies in an aircraft, where defective assemblies or cables may only be bridged and not simply be disconnected. Unlike electric vehicles on the ground, the battery or the fuel cell in an aircraft must continue to operate even after an incident to prevent it from crashing.

In FIG. 12A, the contact elements 2a and 2b, the contact elements 2c and 2d, and the contact elements 2e and 2f each form contact element pairs. The contact elements 2a to 2f are preferably arranged in a plane so that a contact piece 3 can contact all contact elements 2a to 2f simultaneously. FIG. 12B shows the arrangement of a plurality of contact elements 2a to 2f according to FIG. 12A in the electrically connected state that are connected to one another via a single contact piece 3. The contact piece 3 is preferably designed so that, during the change from the disconnected to the connected state of a connection switching member 1 according to the invention, which contains the arrangement shown, all contact elements 2a to 2f are contacted by the contact piece 3. In this way, a current I can flow across the contact elements 2a to 2f.

FIG. 13A to 13D at the top show side views of various contact pieces 3 that can be used according to the invention. The middle views show the same contact pieces 3 tilted downwards by 90°. The lower views show cross-sections of the contact pieces 3 of the middle views, but again tilted downwards by 90°. FIG. 13A shows a contact piece 3 with a linear cutting edge as a penetrating body 4. In FIG. 13B and 13C, the contact pieces 3 have a plurality of penetrating bodies 4, each of which is conical in FIG. 13B, wherein the cones have a recess such that each cone has a circular cutting edge. In FIG. 13C, the penetrating bodies 4 are designed as conventional cones. FIG. 13D shows a contact piece 3 in which the penetrating body 4 is designed as a circular cutting edge.

FIG. 14A shows an electrical connection switching member 1 according to the invention in the electrically disconnected state in a section along the axis 5 of the movement path of the contact piece 3, wherein the contact elements 2a and 2b have cutting edges as penetrating bodies 4, wherein the contact piece 3 can be pulled towards the contact elements 2a and 2b. For this purpose, the contact piece 3 is preferably connected to a sabot 14 via a connecting element 17. The sabot 14 is preferably located within a sabot housing 15 and is preferably attached to the side, opposite the side on which the contact element 3 is located, of the contact elements 2a and 2b. The sabot housing 15 preferably has an opening (not provided with reference signs) for the connecting element 17. In order to allow pressure to build up on the sabot 14 when the pyrotechnic drive 6a is ignited, the housing has a connecting element seal 18 at the aforementioned opening. In addition, the sabot 14 can have one or more sabot seals 11 on the connection surface to the inner wall of the sabot housing 15. The sabot housing 15 is preferably hollow-cylindrical, and the base of the sabot 14 is designed to be circular. It is then preferred that the sabot seal 11 surround the circular sabot as an annular element. As shown in FIG. 14A, the connection switching member 1 according to the invention can have a second, redundant pyrotechnic drive 6a. This makes it possible to increase the reliability of the switching of the connection switching member 1 when the first pyrotechnic drive 6a cannot be ignited. In this case, the pyrotechnic drive 6a is preferably located on the side of the sabot 14 from which the sabot 14 is driven away when the pyrotechnic drive 6a is ignited. When the sabot 14 is moved, the contact piece 3 is pulled towards the contact elements 2a and 2b. In this case, the penetrating bodies 4, designed as cutting edges, of the contact elements 2a and 2b cut into the contact piece 3. In this way, a current I can flow between the two contact elements 2a and 2b, as shown in FIG. 14B, in which the connection switching member 1 is in the connected state. After ignition, the pyrotechnic drive(s) 6b is/are in the triggered state.

FIG. 15A shows an electrical connection switching member 1 according to the invention in the electrically disconnected state in a section along the axis 5 of the movement path of the contact piece 3, wherein the contact elements 2a and 2b have cutting edges as penetrating bodies 4, wherein the contact piece 3 can be pulled towards the contact elements 2a and 2b. Except for the interior of the sabot housing 15, the connection switching member 1 of FIG. 15A does not differ from the connection switching member 1 of FIG. 14A, to which reference is hereby made. In this case, however, the pyrotechnic drive 6a is preferably located on the side of the sabot 14 to which the sabot 14 is driven after the pyrotechnic drive 6a is triggered. For this purpose, a gas-conducting body 16 is provided in the interior of the sabot housing 15 and divides the interior of the sabot housing 15 substantially into two chambers, which are preferably connected via a gas-conducting channel between the gas-conducting body 16 and the inner wall of the sabot housing 15. When the pyrotechnic drive 6a is ignited, a pressure is built up on the sabot 14 via the gas-conducting channel, and the connection switching member 1 changes from the disconnected state to the connected state. As a result, the contact element 3 is moved towards the penetrating bodies 4, designed as cutting edges, of the contact elements 2a and 2b, so that the cutting edges can penetrate the contact piece 3, and a current can flow between the contact elements 2a and 2b. FIG. 15B shows the connection switching member 1 of FIG. 15A in the connected state in which it has been ignited by the pyrotechnic drive 6b.

### List of Reference Signs

1 Electrical connection switching member
2a to 2f Electrical contact elements
3 Contact piece
4 Penetrating body
5 Axis/direction of the movement path of the contact piece/imaginary central axis
6a Pyrotechnic drive before it is triggered
6b Pyrotechnic drive after it is triggered
7 Combustion chamber/piston housing
8 First piston
9 Second piston
10 Stop element for the second piston
11 Piston seal/sabot seal
12 Electrical terminals for the pyrotechnic drive
13 Combustion chamber
14 Sabot
15 Sabot housing
16 Gas-conducting body
17 Connecting element between the sabot and contact piece
18 Connecting element seal
F Force
v Speed
I Electrical current

1. Electrical connection switching member (1) having at least two electrically conductive contact elements (2a to 2f) and an electrically conductive contact piece (3) for connecting the contact elements (2a to 2f),
wherein the contact piece (3) is movable by means of a pyrotechnic drive (6a, 6b) along a movement path, and, as a result, the connection switching member (1) can be changed from an electrically disconnected state to an electrically connected state, wherein the contact piece (3) is designed so that the contact piece (3) in the disconnected state does not electrically connect the contact elements (2a to 2f) and in the connected state electrically connects the contact elements (2a to 2f),
wherein the contact piece (3) or the contact elements (2a to 2f) have at least one penetrating body (4), which is designed so that, during the change from the electrically disconnected state into the electrically connected state, the penetrating body (4) penetrates into the contact piece (3) or the contact elements (2a to 2f) by cutting or piercing.

2. Connection switching member (1) according to claim 1, wherein the pyrotechnic drive (6a, 6b) is located within a housing together with the contact piece (3) and the contact elements (2a to 2f).

3. Connection switching member (1) according to claim 1 or 2, wherein the penetrating body (4) is designed as a wedge, cutting edge, or spike.

4. Connection switching member (1) according to any of claims 1 to 3, wherein the contact piece (3), the contact elements (2a to 2f), or the penetrating body (4) is/are made of an electrically conductive material—preferably metal or a conductive plastic.

5. Connection switching member (1) according to claim 4, wherein the contact piece (3), the contact elements (2a to 2f), or the penetrating body (4) is/are made of metal—preferably stainless steel, copper, or brass.

6. Connection switching member (1) according to any of claims 1 to 5, wherein the contact piece (3) itself is designed as a piston (7), or is connected to a piston (7) at least in the disconnected state, wherein the piston (7) is movable by means of the pyrotechnic drive (6a, 6b) along the movement path.

7. Connection switching member (1) according to any of claims 1 to 5, which has a pyrotechnic pin puller that is designed so that the contact piece (3) is pulled towards the contact elements (2a to 2f).

8. Connection switching member (1) according to any of claims 1 to 7, having three or more contact elements (2a to 2f), wherein the contact piece (3) is designed so that the contact piece in the disconnected state does not electrically connect the contact elements (2a to 2f) and in the connected state electrically connects the three or more contact elements (2a to 2f).

9. Connection switching member (1) according to claim 8, wherein the contact piece (3) has the penetrating body (4).

10. Connection switching member (1) according to claim 9, wherein the penetrating body (4) is designed so that it penetrates into the three or more contact elements (2a to 2f).

11. Use of a connection switching member (1) according to any of claims 1 to 10 for short-circuiting a circuit on a fuel cell.

12. Use of membranes or material weakenings in the housing of a connection switching member (1) according to any of claims 1 to 10 for short-circuiting a circuit as a protective function against bursting of the housing during the switching process.
